(19) United States
(12) Patent Application Publication
(10) Pub. No.: US 2002/0126975 A1
(43) Pub. Date: Sep. 12, 2002

(54) Optical fiber with metal coating for illumination

(76) Inventor: Li Chieh Huang, Hsinchu (TW)

Correspondence Address: BACON & THOMAS, PLLC, 625 SLATERS LANE, FOURTH FLOOR, ALEXANDRIA, VA, 22314

(21) Appl. No.: 09/962,320

(22) Filed: Sep. 26, 2001

(30) Foreign Application Priority Data
Mar. 9, 2001 (TW) 90105664

(51) Int. Cl. G02B 6/22

(52) U.S. Cl. 385/128

(57) ABSTRACT

The invention, the optical fiber with metal coating is a glasses fiber, and the surface of the fiber is wrapped with a thin metal coating. In an aspect of the invention, the optical fiber with metal coating can guide the visible and infrared light from the light source to the guide's terminating face more efficiently. By the total reflection that occurred at the surface of optical fiber/metal coating interface (about the transmitted/guided light within the fiber), the metal coating can keep the leakage of the transmitted light within the fiber away, and maintain the transmitted light to stay in the optical fiber. So the purpose to transmit and directing light through the optical fiber more efficiently can achieve by this invention.

### BACKGROUND OF THE INVENTION

1. Field of the Invention

The invention, the optical fiber with metal coating is a glasses fiber, and the surface of the fiber is wrapped with a thin metal coating. In an aspect of the invention, the optical fiber with metal coating can guide the visible and infrared light from the light source to the guide's terminating face more efficiently. By the total reflection that occurred at the surface of optical fiber/metal coating interface (about the transmitted/guided light within the fiber), the metal coating can keep the leakage of the guided light within the fiber away, and maintain the guided light to stay in the optical fiber. So the purpose to guide and directing light through the optical fiber more efficiently can achieve by this invention.

2. Description of the Prior Art

Generally, the guided efficiency about optical fiber (not the telecommunication fiber) for the light beam that pass through the optical fiber is not well, the major factor to cause this phenomenon is that the power loss of the light beam that coupling into and being guided inside the optical fiber is too high. The causes for the power loss of the optical fiber are:

1. The material character of the optical fiber is one of the cause for high power loss of the optical fiber, and this is the generally shortcomings for the plastics optical fiber.

2. The optical fiber can not restrict the light beam to guided completely inside the optical fiber, so the light beam that coupling into the optical fiber might refract and leak out of the optical fiber. And this is the other one factor to cause the power loss of the optical fiber for the light beam that guided inside of the optical fiber.

### SUMMARY OF THE INVENTION

To solve the problem about the high power loss of the optical fiber for the light beam that guided inside of the optical fiber, we should choose the glass optical fiber as our guided light beam media for it's low power loss material character compare to the plastics optical fiber. For the purpose of mass production easily, the glass optical fiber only need one single index glass to guided the light beam that pass through the optical fiber and the material character of glass optical fiber must avoid the high power loss for the light beam that guided inside the optical fiber.

Furthermore, to achieve the purpose of restrict the light beam that guided inside the optical fiber completely, we can coated a metal coating on the surface of the optical fiber to reflect the light beam that guided inside of the optical fiber, and by the reflection of the light beam that guided inside of the optical fiber on the optical fiber/metal coating interface, we can keep the leakage of the guided light beam within the fiber away, and maintain the transmitted light beam to stay in the optical fiber and avoid the high power loss of the light beam that guided inside of the optical fiber.

### BRIEF DESCRIPTION OF THE DRAWINGS

The invention, as well as it's many advantages, may be further understood by the Following detailed description and drawings in which:

FIG. 1 shows a metal coating on the surface of the optical fiber to reflect the light beam guided inside of the optical fiber, and by the reflection of the light beam that guided inside of the optical fiber on the optical fiber/metal coating interface, we can keep the leakage of the guided light beam within the fiber away, and maintain the guided light beam to stay in the optical fiber.

FIG. 2 shows cross-sectional views of the optical fiber with nickel coating on the surface by scanning electron microscope (SEM).

FIG. 3. shows the composition analysis of the metal coating about FIG. 2.

FIG. 4. shows cross-sectional views of the optical fiber with nickel and copper multi-layer coating on the surface by scanning electron microscope (SEM).

FIG. 5 shows the composition analysis of the metal coating about FIG. 4

### DETAILED DESCRIPTION OF THE PREFERRED EMBODIMENT

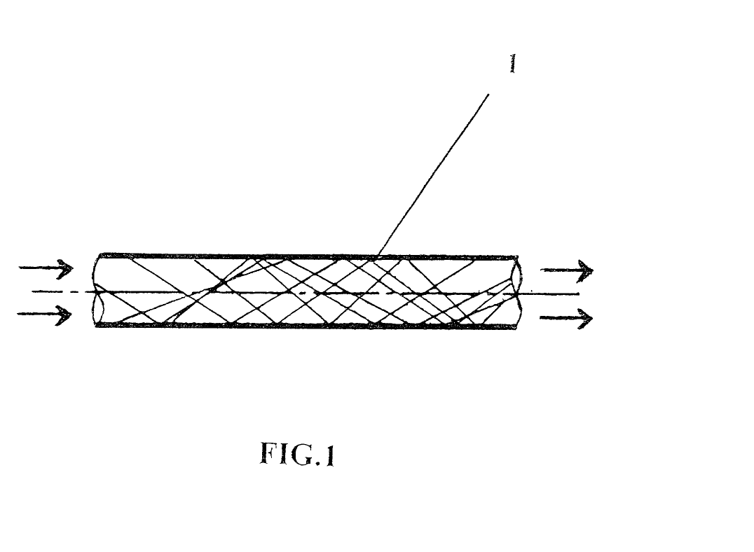

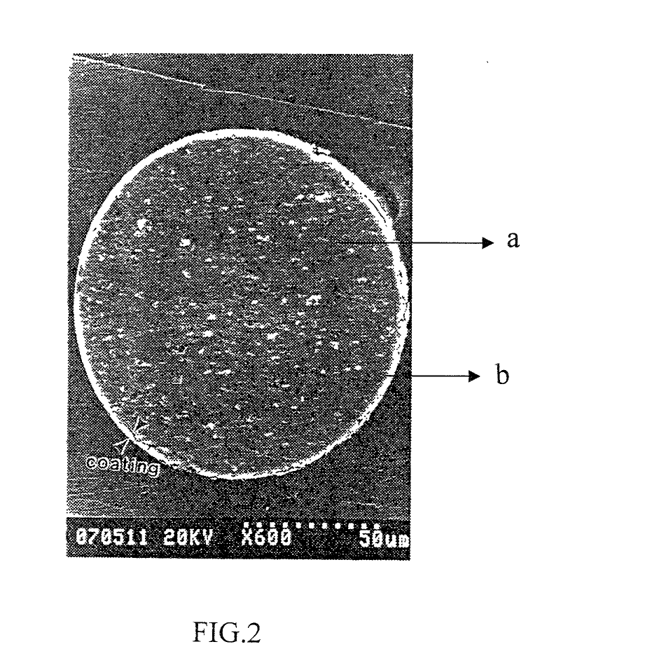

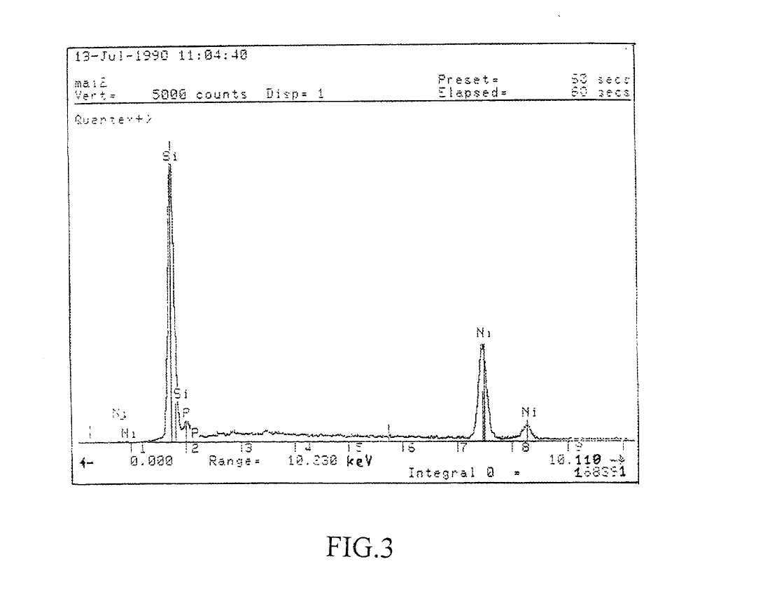

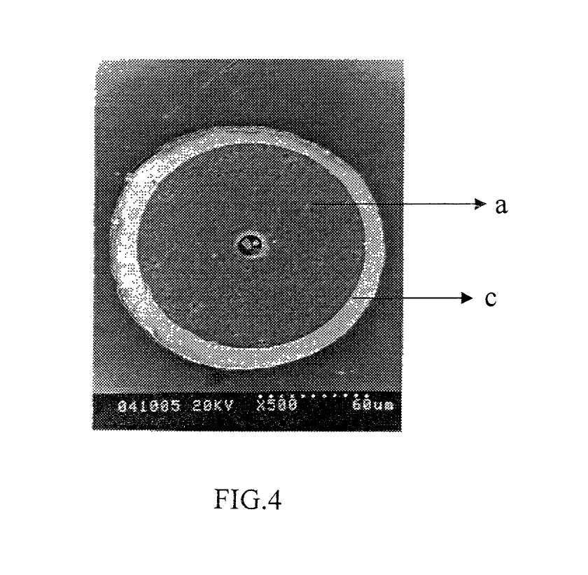

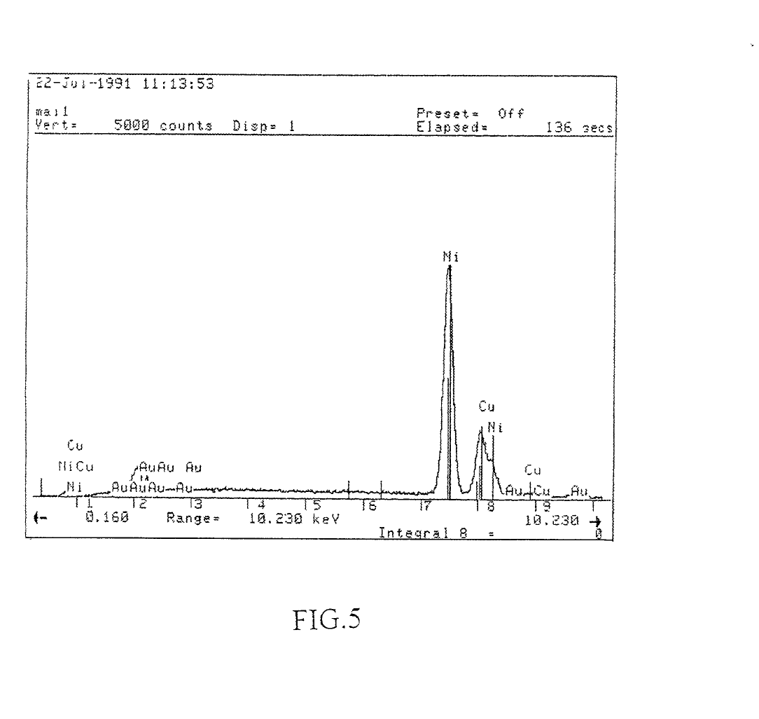

As described above, the invention provides the optical fiber with metal coating for illumination and process for fabricating the same. As show in figure, especially, the optical fiber 1 comprises the glass optical fiber a and nickel metal plating layer b in cross-sectional show in FIG. 2 and the analysis show in FIG. 3, and as show in FIG. 4, used multi-layer(copper plating layer add nickel metal plating layer) c to coated on the surface of an optical fiber with nickel and copper, and the analysis in FIG. 5. In an aspect of the invention, as show in FIG. 1, the metal coating on the surface of the optical fiber is fabricated by electroless plating method. By this fabrication, we can get a thin metal coating on the surface of the optical fiber, and the thin metal coating on the surface of the optical fiber can reflect the light beam that guided inside of the optical fiber in the way just like the reflect film on the back of the mirror and can restrict the light beam that guided inside the optical fiber completely.

1. An optical fiber with metal coating comprising:
a. with a thin metal coating on the surface of the glass optical fiber, and
b. the optical fiber can guided the light beam inside of the optical fiber.

2. An optical fiber with metal coating as in claim 1, wherein the light beam that guided inside of the optical fiber include visible and infrared light beam.

3. An optical fiber with metal coating as in claim 1, wherein the glass optical fiber only need one single index glass to guided the light beam that pass through the optical fiber.

4. An optical fiber with metal coating as in claim 1, wherein the optical fiber is coated a thin metal coating on the surface of the optical fiber and the thin metal coating on the surface can reflect the light beam that guided inside of the optical fiber just like the reflective film on the back of the mirror, and by the reflection of the light beam that guided inside the optical fiber on the optical fiber/metal coating interface, the optical fiber with metal coating can keep the leakage of the guided light beam within the fiber away.

5. An optical fiber with metal coating as in claim 1, wherein the thin nickel metal coating on the surface of the optical fiber is fabricate by electroless plating method.

6. An optical fiber with metal coating as in claim 1, wherein the thin nickel and copper multi-layer metal coating on the surface of the optical fiber is fabricate by electroless plating method.
